(19) United States
(12) Patent Application Publication
(10) Pub. No.: US 2025/0391128 A1
(43) Pub. Date: Dec. 25, 2025

(54) SETTING METHOD, SETTING DEVICE, AND COMPUTER PROGRAM

(71) Applicant: PwC Consulting LLC, Tokyo (JP)

(72) Inventors: Satoshi Yanagisawa, Tokyo (JP); Tomohiro Sasaki, Tokyo (JP); Shiori Ozono, Tokyo (JP)

(21) Appl. No.: 19/216,956

(22) Filed: May 23, 2025

(30) Foreign Application Priority Data
May 24, 2024 (JP) 2024-085016

(51) Int. Cl. G06T 19/00; G06V 20/17; G06V 20/20

(52) U.S. Cl. CPC G06T 19/006; G06V 20/17; G06V 20/20

(57) ABSTRACT

A value of a three-dimensional space is set. A setting method sets the value of the three-dimensional space executed in an arithmetic circuit connected to a storage device. The three-dimensional space includes a plurality of unit spaces, and identification information for uniquely identifying each unit space is assigned to each unit space. The storage device stores space utilization information in which identification information of a plurality of unit spaces is associated with information indicating a frequency at which each unit space is used per unit time. In the setting method, an arithmetic circuit reads space utilization information from the storage device, calculates a use rate of each unit space by using a frequency at which each unit space represented by the space utilization information is used per unit time, and sets value information indicating a value of each unit space according to the use rate of each unit space.

### CROSS REFERENCE TO RELATED APPLICATIONS

This application is a continuation of Japanese Patent Application No. 2024-85016, filed on May 24, 2024, the entirety content of which is incorporated herein by reference.

### BACKGROUND

### 1. Technical Field

The present invention relates to a setting method, a setting device, and a computer program for setting a value of a three-dimensional space.

### 2. Explanation of Related Art

In recent years, geospatial information has been widely used. Utilizing geospatial information can provide a digital twin that integrates real-world data into virtual space. In addition, for example, there is a technology of dividing a three-dimensional space, managing the space, and using the space (see, for example, Japanese Patent Application Laid-Open No. 2023-112672.).

Incidentally, conventionally, values for land and features are finely defined. On the other hand, the value of the space utilized in the geospatial information is not defined. For example, at present, a value is not defined in a three-dimensional space such as space, air, ground, and sea. As the use of geospatial information increases, the definition of the value of a three-dimensional space is expected to be desired.

### SUMMARY

In view of the above, the present invention provides a setting method, a setting device, and a computer program for setting a value of a three-dimensional space.

A setting method according to the present invention sets a value of a three-dimensional space executed in an arithmetic circuit connected to a storage device. The three-dimensional space includes a plurality of unit spaces, and identification information for uniquely identifying each unit space is assigned to each unit space. The storage device stores space utilization information in which identification information of a plurality of unit spaces is associated with information indicating a frequency at which each unit space is used per unit time. In the setting method, an arithmetic circuit reads space utilization information from the storage device, calculates a use rate of each unit space by using a frequency at which each unit space represented by the space utilization information is used per unit time, and sets value information indicating a value of each unit space according to the use rate of each unit space.

The setting method, the setting device, and the computer program of the present invention can set a value of a three-dimensional space.

### BRIEF DESCRIPTION OF DRAWINGS

FIG. 1 is a block diagram illustrating a configuration of a setting device according to an embodiment;

FIG. 2A is a schematic diagram illustrating an example of a unit space handled by the setting device;

FIG. 2B is a schematic diagram illustrating an example of displaying a value in association with a unit space handled by the setting device;

FIG. 3 is a schematic diagram illustrating a concept of dynamic pricing;

FIG. 4 is a schematic diagram illustrating an example of a configuration of three-dimensional space information;

FIG. 5 is a schematic diagram illustrating a three-dimensional map represented using three-dimensional map information;

FIG. 6 is a flowchart illustrating an example of processing executed by the setting device of FIG. 1;

FIG. 7 is an example of a composite image generated by the setting device;

FIG. 8 is a block diagram illustrating a configuration of a setting device according to a first modification;

FIG. 9 is a block diagram illustrating a configuration of a setting device according to a second modification;

FIG. 10 is a schematic diagram illustrating an example of a configuration of drone information; and

FIG. 11 is a flowchart illustrating an example of processing executed by the setting device of FIG. 10.

### DESCRIPTION OF PREFERRED EMBODIMENTS

Hereinafter, a setting device according to the present invention will be described with reference to the drawings. The setting device of the present invention sets a value of a unit space in consideration of a use rate of each unit space in a plurality of unit spaces defined on a three-dimensional space. Note that, in the following description, the same components are denoted by the same reference numerals, and description thereof is omitted.

### <Information System>

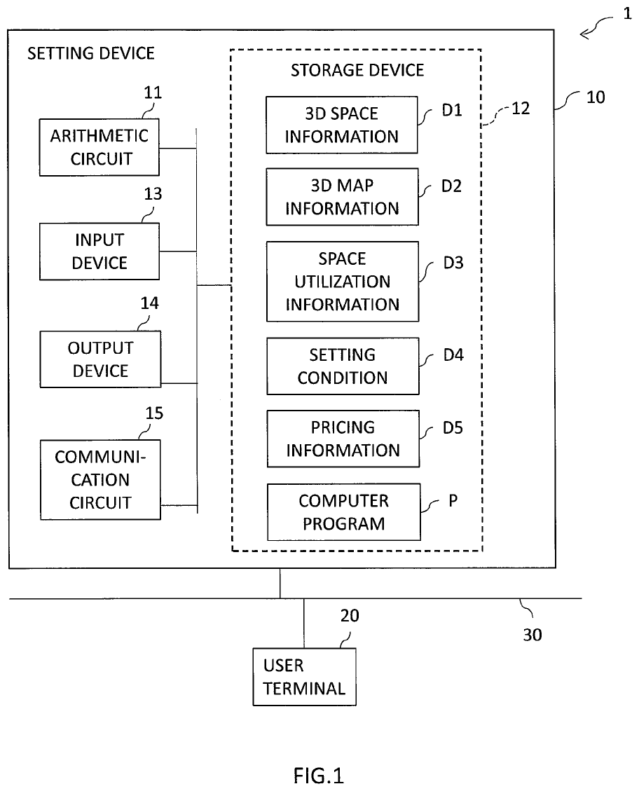

As illustrated in FIG. 1, a setting device 10 of the present invention is included in an information system 1. The setting device 10 is data-communicably connected to a user terminal 20 via a network 30. The setting device 10 sets a value of a three-dimensional space. The three-dimensional space includes a plurality of unit spaces, and identification information for uniquely identifying each unit space is assigned to each unit space. A storage device 12 of the setting device 10 stores space utilization information D3. The space utilization information D3 associates identification information of a plurality of unit spaces with information indicating a frequency at which each unit space is used per unit time. The setting device 10 reads the space utilization information D3 from the storage device 12. In addition, the setting device 10 calculates the use rate of each unit space by using the frequency at which each unit space represented by the space utilization information D3 is used per unit time. Thereafter, the setting device 10 sets value information indicating the value of each unit space according to the use rate of each unit space. Further, the setting device 10 generates the pricing information in which the identification information and the value information are associated with each other for each unit space and stores the generated pricing information in the storage device 12.

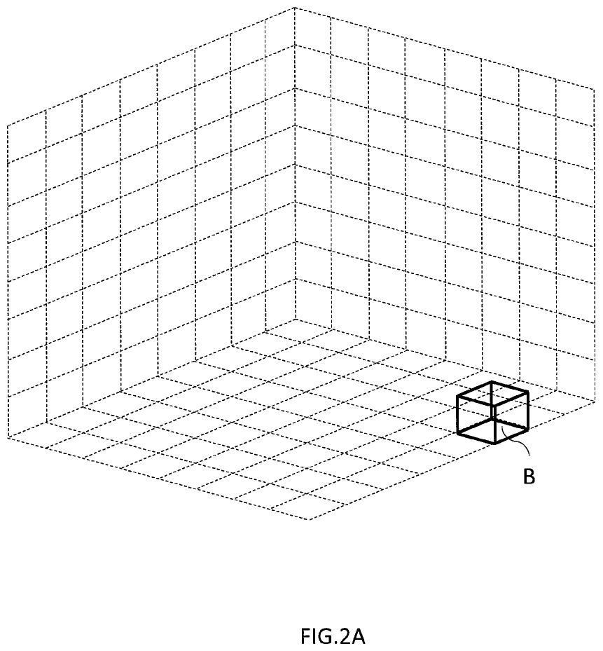

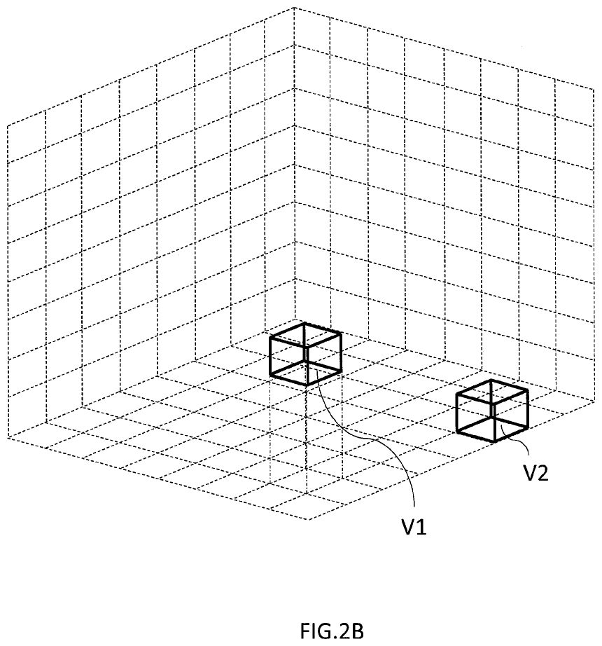

For example, as illustrated in FIG. 2A, the three-dimensional space is divided into a plurality of unit spaces B in advance. FIG. 2A illustrates a concept of dividing a three-dimensional space. Therefore, all the divided unit spaces B are not illustrated in FIG. 2A. In the example illustrated in FIG. 2A, the unit space B is a cube. In other words, the three-dimensional space can be represented by a plurality of voxels.

In the following embodiment, the unit space will be described as an example of a cube. However, the unit space may be another polyhedron. At this time, the shape of the unit space is preferably a shape that can focus the three-dimensional space without a gap. Other polyhedrons may include a rectangular parallelepiped, a parallelepiped, and the like.

Furthermore, the arithmetic circuit 11 can display an image indicating the three-dimensional space including the set value on the display of the user terminal 20. For example, as illustrated in FIG. 2B, the arithmetic circuit 11 may display only values V1 and V2 of some unit spaces. As a result, for example, a user can compare the values V1 and V2 of the target unit space.

The user terminal 20 is an information processing terminal used by the user. The user terminal 20 receives the image transmitted by the setting device 10 and displays the image on the display. For example, the user terminal 20 may be a personal computer (PC) having a display, a smartphone, or the like.

In FIG. 1, the setting device 10 is connected to one user terminal 20, but the number of user terminals 20 connected to the setting device 10 is not limited. Therefore, the setting device 10 may display the same or different images on a plurality of different user terminals 20.

### <Setting Device>

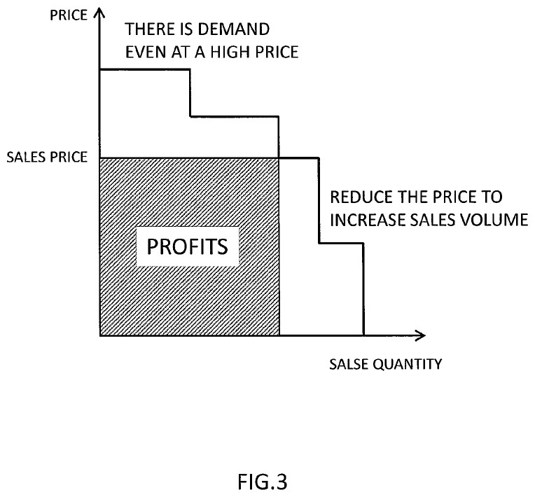

Specifically, the setting device 10 can vary the value of the unit space by adopting the general idea of dynamic pricing illustrated in FIG. 3. The dynamic pricing is a method of varying the price of goods or services according to the status of demand and supply. In the example illustrated in FIG. 3, the vertical axis represents the price of the product, and the horizontal axis represents the sales quantity of the product. In general, higher prices tend to result in lower sales quantity. Here, when the demand is high, there is a person who wishes to purchase an item even if the price is higher than a preset sales price. On the other hand, in a case where the demand is low, a person who wishes to purchase an item is likely to occur by setting the price lower than the preset sales price. Therefore, in dynamic pricing, the price is flexibly varied according to demand. When setting the value of the unit space as in the example of the dynamic pricing, the setting device 10 sets the value of the unit space having a high use rate to be higher than the value of the unit space having a low use rate.

The setting device 10 according to the embodiment will be described with reference to FIG. 1. For example, as illustrated in FIG. 1, the setting device 10 is an information processing device such as a personal computer including an arithmetic circuit 11, a storage device 12, an input device 13, an output device 14, and a communication circuit 15.

The arithmetic circuit 11 is a controller that controls the entire setting device 10. The arithmetic circuit 11 executes various processes by executing a computer program P stored in the storage device 12. Furthermore, the arithmetic circuit 11 may be a hardware circuit exclusively designed to realize a predetermined function. For example, the arithmetic circuit 11 may be various processors such as a CPU, an MPU, a GPU, an FPGA, a DSP, and an ASIC.

The storage device 12 is a storage medium that records various types of information. The storage device 12 is realized by, for example, a RAM, a ROM, a flash memory, a solid state drive (SSD), a hard disk drive, other storage devices, or an appropriate combination thereof. The storage device 12 can store three-dimensional space information D1, three-dimensional map information D2, space utilization information D3, a setting condition D4, pricing information D5, and the like. In addition, the storage device 12 stores various data used in the process of the setting processing.

The input device 13 is an operation button, a keyboard, a mouse, a touch panel, a microphone, or the like operated by an operator. Furthermore, the output device 14 is a display, a speaker, or the like used to output a processing result or data.

The communication circuit 15 is a communication means for enabling data communication with an external device such as the user terminal 20. Data communication may be conducted in accordance with known wireless and/or wired communication standards via the network 30. For example, wired data communication is performed by using, as the communication circuit 15, a communication controller of a semiconductor integrated circuit that operates in conformity with the Ethernet (registered trademark) standard and/or the USB (registered trademark) standard. In addition, wireless data communication is performed by using, as the communication circuit 15, a communication controller of a semiconductor integrated circuit that operates in accordance with the IEEE802.11 standard related to a local area network (LAN) and/or a fourth generation/fifth generation mobile communication system called 4G/5G related to moving body communication.

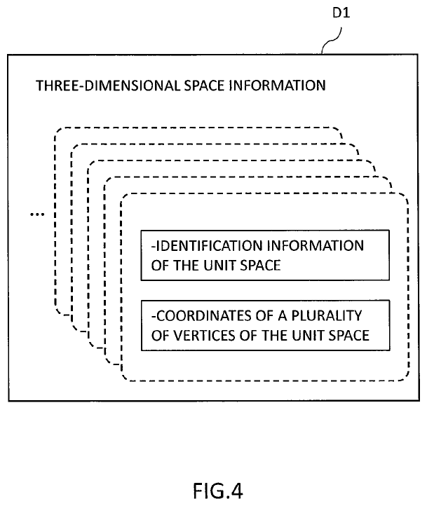

The three-dimensional space information D1 is information indicating each unit space obtained by dividing the three-dimensional space into a plurality of unit spaces. Unique identification information is assigned to each unit space. For example, as illustrated in FIG. 4, the three-dimensional space information D1 includes identification information of the unit space and coordinates of a plurality of vertices of the unit space. The coordinates of the unit space may be coordinates of each vertex of the unit space. The unit space may be, for example, a cube. Therefore, as illustrated in FIG. 2A, when the unit space is a cube, the identification information of each unit space can associate the coordinates of eight vertices in the three-dimensional space information D1.

Further, the three-dimensional space information D1 can associate a three-dimensional tile number (ZFXY) of each unit space with the identification information of each unit space. The three-dimensional tile number of the unit space is a number assigned to a surface included in a surface constituting the unit space. If the unit space is a rectangular parallelepiped, the unit space is formed by six surfaces. In this case, six three-dimensional tile numbers are associated with the identification information of one unit space. In addition, if the unit space is a hexagonal prism, the unit space is formed by eight surfaces. In this case, eight three-dimensional tile numbers attached to the respective surfaces are associated with the identification information of one unit space.

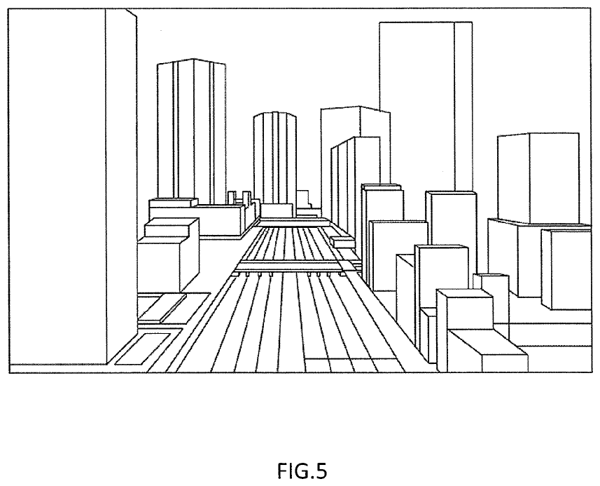

The three-dimensional map information D2 is information used for drawing a three-dimensional map of a space in association with the three-dimensional space information D1. For example, the three-dimensional map information D2 includes information on the outside and/or the outside of a building present in the space. The three-dimensional map as illustrated in FIG. 5 can be represented by the three-dimensional map information D2.

The three-dimensional map information D2 may be represented by an absolute coordinate system corresponding to the coordinates of the three-dimensional space information D1. In the information system 1, coordinates are uniformly expressed using the absolute coordinate system, so that each processing can be efficiently executed without performing coordinate transformation in each processing.

The space utilization information D3 is information that associates identification information of each unit space with information indicating use of each unit space. For example, the space utilization information D3 can include information indicating that each unit space has been used in the past and reservation information indicating that each unit space will be used in the future. Specifically, the space utilization information D3 can associate a date and time when the unit space has been used in the past and a date and time of a schedule to be used in the future with the identification information of the unit space.

The setting condition D4 is a condition used for setting the value of the unit space. The setting condition D4 may include information on the use rate of the unit space. Specifically, the setting condition D4 can include a use rate for each time at which the unit space is used. In addition, the setting condition D4 may include a use rate for each object using the unit space. Here, the use rate can be calculated using the space utilization information D3. For example, the use rate of each unit space may be calculated by the arithmetic circuit 11.

Furthermore, when there is a space whose use is restricted in the three-dimensional space, the setting condition D4 may include information on restriction of use of the unit space. For example, in a case where the unit space cannot be used due to circumstances such as legal regulations and troubles, the setting condition D4 includes information indicating that the unit space cannot be used and/or a date and time when the unit space cannot be used.

### (Use Rate of Unit Space)

The use rate of each unit space in a certain time zone is calculated by using, for example, the use frequency of the unit space in the time zone and the use frequency of the unit space in the same time zone in the past year. At this time, the use frequency for each day of the week may be considered in addition to the time zone. Note that UNIX time may be used as the time.

For example, the following Formula (1.1) can be used to calculate the use rate R of a certain unit space for 59 seconds from 12:01:00 on Wednesday, December 12.

$$R = C 1 / C 2 \qquad ( 1.1 )$$

C1: The number of times the target unit space is used and/or is to be used for 59 seconds from 12:01:00, Wednesday, December 12.
C2: The number of times the target unit space is used and/or is to be used for 59 seconds from 12:01:00 on Wednesday in the past 1 year

Note that only one use is allocated to each unit space. Therefore, the unit space is not used for two or more purposes at the same time. In the above example, the number of times when the use from 12:01:00 to 29 seconds is reserved is 1. In addition, the number of times when the use from 12:01:00 to 19 seconds and the use from 12:01:20 to 39 seconds are reserved is 2.

The pricing information D5 is information that associates the identification information of the unit space with the value of the unit space calculated by the setting device 10. For example, the value of the unit space can be indicated by an amount of money generated by using the unit space.

### (Value of Unit Space)

The value of each unit space may be different for each altitude, for example. At this time, the base unit price may be determined according to the altitude of the unit space. Specifically, the base unit price may be set every 10 m, and the higher the altitude, the lower the fee. Note that, in a case where the space can be defined by the elevation, the altitude may be treated instead of the elevation or the sea level.

For example, the following Formula (1.2) can be used to calculate the value P of a certain unit space having an altitude of 105 m in a unit time of 59 seconds from 12:01:00 on Wednesday, December 12.

$$P = Pb \times R \qquad ( 1.2 )$$

Pb: Base unit price of unit space at altitude of 100 to 110 m
R: Use rate of target unit space in target unit time

The pricing information D5 includes the value P for each unit space calculated in this manner.

Note that, in Formula (1.2), the base unit price of the unit space and the use rate of the unit space are used to calculate the value of the unit space. However, other elements may be used to calculate the value of the unit space. For example, the calculation of the value of the unit space may include the use rate at that time. Specifically, when there is one unit space available in the target unit time, the value of the unit space may be increased. Furthermore, for example, the calculation of the value of the unit space may include a day of the week, whether or not it is a holiday, a date, and the like. Specifically, a coefficient determined according to the day of the week, whether or not it is a holiday, the date, and the like may be added to or multiplied by the calculation formula of the value of the unit space.

In a case where there is a building or the like in each unit space, the base unit price can reflect a value according to the rent price of each unit space, the population of each unit space, and the number of people staying acquired by the IoT sensor installed in each unit space. In addition, in a case where the data regarding the rent price, the population, and the number of people staying does not include the information on the altitude, the base unit price may be calculated by multiplying or adding a coefficient according to the altitude. In addition, a different base unit price may be used for each use of the unit space.

Note that a coefficient that varies the value P of the unit space may be used in Formula (1.2) according to the idea of the zoom level used in the spatial voxel. At this time, the value P of the unit space may not be proportional to the size of the unit space. That is, in a so-called volume discount, the price and the amount are not proportional. For example, when the unit space becomes ⅛, the value of the unit space may be set higher than ⅛ instead of ⅛. In addition, when the unit space becomes eight times, the value of the unit space may be less than eight times instead of eight times.

### <Value Setting Processing of Each Unit Space in Setting Device>

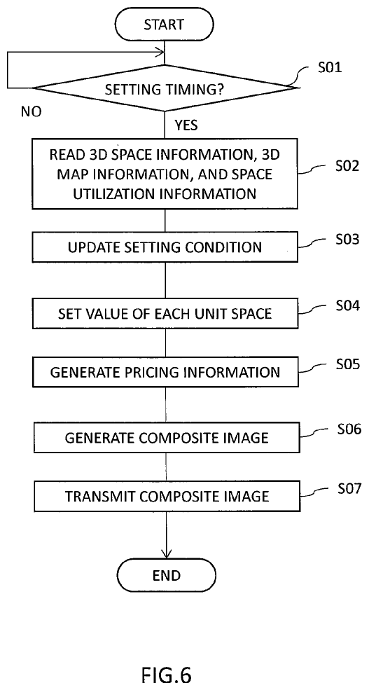

An example of a flow of processing of setting the value of the space information used by the setting device 10 will be described with reference to a flowchart illustrated in FIG. 6.

The arithmetic circuit 11 determines whether or not it is a setting timing of the value of the unit space (S01). The setting timing may be, for example, a periodic timing, a timing at which a request is received from the user terminal 20, or the like. Furthermore, for example, a timing at which a value of each unit space of the three-dimensional space changes can be set as the setting timing.

When it is the setting timing (YES in S01), the arithmetic circuit 11 reads the three-dimensional space information D1, the three-dimensional map information D2, and the space utilization information D3 from the storage device 12 (S02).

The arithmetic circuit 11 updates the setting condition D4 (S03). Specifically, the arithmetic circuit 11 calculates the use rate of each unit space using the space utilization information D3. In addition, the arithmetic circuit 11 updates the use rate associated with the identification information of each unit space in the setting condition D4.

The arithmetic circuit 11 sets the value of each unit space defined by the three-dimensional space information D1 using the use rate included in the setting condition D4 (S04).

The arithmetic circuit 11 generates the pricing information D5 by associating the value of the unit space set in step S04 with the identification information of each unit space (S05). At this time, the setting device 10 stores the generated pricing information D5 in the storage device 12. In addition, when the pricing information D5 generated in the past is stored in the storage device 12, the pricing information D5 is updated in association with the newly set value.

The arithmetic circuit 11 generates a composite image using the three-dimensional space information D1, the three-dimensional map information D2, and the pricing information D5 (S06). In addition, the arithmetic circuit 11 transmits the generated composite image to the user terminal 20 (S07). As a result, in the user terminal 20, the composite image is displayed on the output device 14, and the user can visually confirm the composite image. Note that, in a case where the user's confirmation is unnecessary, the processing of steps S06 and S07 can be omitted.

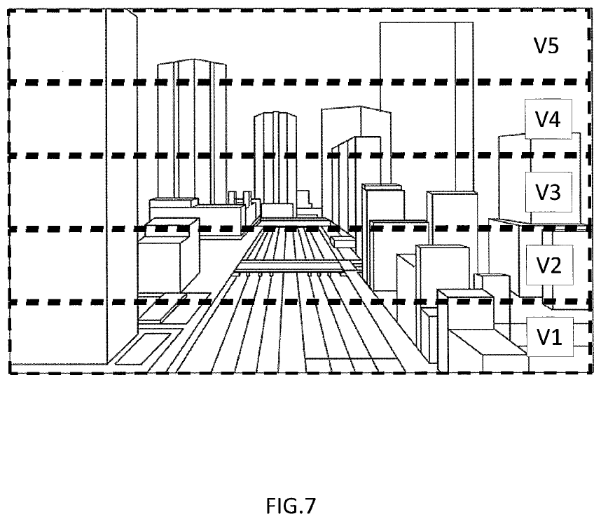

The composite image is, for example, an image obtained by combining each unit space of a map indicating a three-dimensional space and information indicating values V1 to V5 of each unit space, as an example is illustrated in the schematic diagram of FIG. 7. For example, in the composite image, characters and symbols indicating the value of the unit space may be combined with a designated unit space in a map indicating a three-dimensional space. Furthermore, for example, in the composite image, a color determined for each of the values V1 to V5 may be combined with a designated unit space in a map indicating a three-dimensional space.

Note that the composite image illustrated in FIG. 7 is an example in which a plurality of unit spaces to which the same value is set is collectively associated as one value. Specifically, FIG. 7 is an example in which, when the same value is set to the unit spaces of the same altitude, the individual unit spaces to which the same value is set are not distinguished and are indicated as one region in the composite image.

As described above, the setting device 10 according to the present invention can set a value to each unit space of the three-dimensional space. Here, the setting device 10 sets the value of the unit space according to the use rate calculated for each time zone of each unit space. Therefore, the setting device 10 can flexibly set the value of the unit space. Furthermore, the setting device 10 can newly set a value at a timing when a value of each unit space of the three-dimensional space changes. As a result, the user can use the space with a value corresponding to the current situation. Furthermore, the setting device 10 can display the value set for each unit space in association with the map of the three-dimensional space. As a result, the user can easily grasp the value of each unit space.

### First Modification

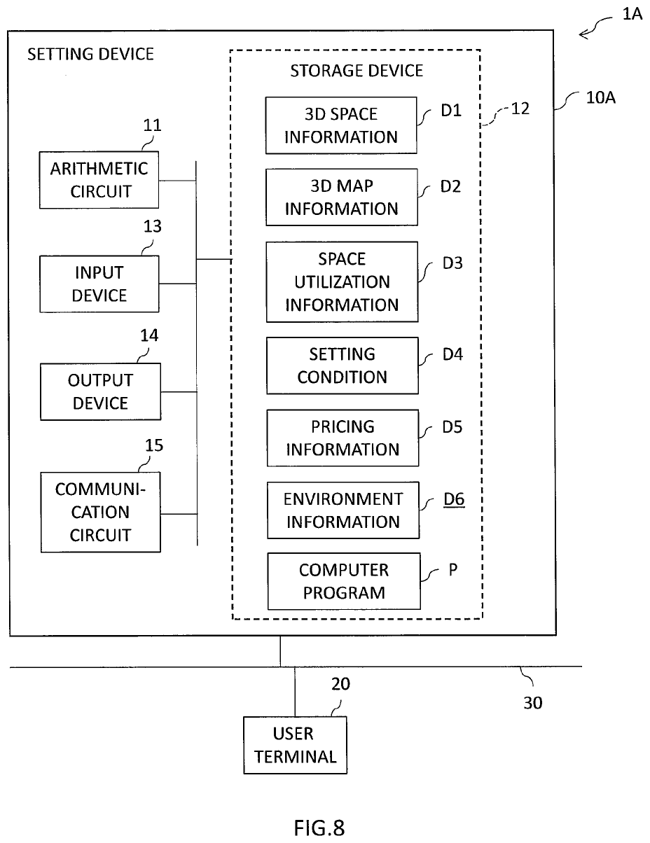

A setting device 10A according to a first modification will be described with reference to FIG. 8. The setting device 10A according to the first modification is different from the setting device 10 illustrated in FIG. 1 in that the environment information D6 is stored in the storage device 12.

The environment information D6 is information related to the environment of the space corresponding to the three-dimensional space information D1. The environmental information D6 can include, for example, weather information in the space, disaster information, and the like. Note that, since the information related to the environment changes from moment to moment, the information can be updated at a periodic timing or a timing when the information changes.

The environment information D6 may be represented by an absolute coordinate system corresponding to the coordinates of the three-dimensional space information D1. In the information system 1, coordinates are uniformly expressed using the absolute coordinate system, so that each processing can be efficiently executed without performing coordinate transformation in each processing.

When setting the value of the unit space, the arithmetic circuit 11 of the setting device 10A can set the value of the unit space of which use is limited low.

As described above, the setting device 10A according to the first modification can more flexibly set the value of the unit space according to the environment.

### Second Modification

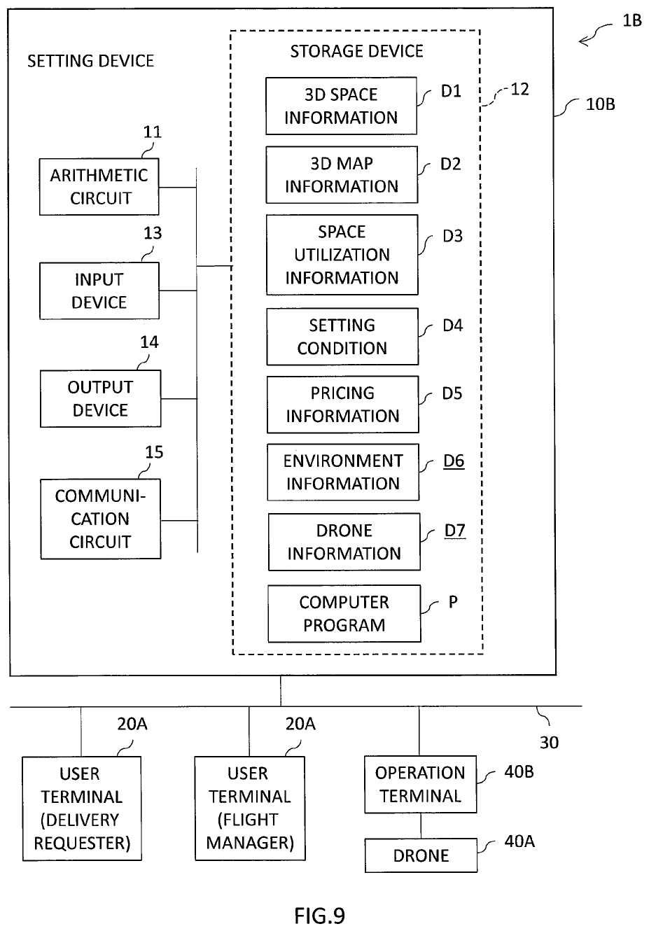

A setting device 10B according to a second modification will be described with reference to FIG. 9. The setting devices 10 and 10A described above with reference to FIGS. 1 and 8 simply set the value of the unit space. The setting device 10B according to the second modification sets the value of the unit space and generates a route for moving in the unit space. Specifically, an example will be described in which the setting device 10B determines the route of the moving body in which the moving body delivers the product from a predetermined landing to the destination, and returns to the landing after the delivery. The setting device 10B can use the value of the unit space to determine the route and the fee used for delivery of the product. Hereinafter, an example in which the moving body is a multicopter that flies in the air will be described. More specifically, an example in which the multicopter is a drone will be described.

The setting device 10B according to the second modification is different from the setting device 10 illustrated in FIG. 1 in that a user terminal 20A of a requester who requests delivery of a product, a user terminal 20B of a flight manager who manages delivery using a drone, and an operation terminal 40B that operates a drone 40A are connected. In addition, the setting device 10B is different in that the environment information D6 and the drone information D7 are stored in the storage device 12.

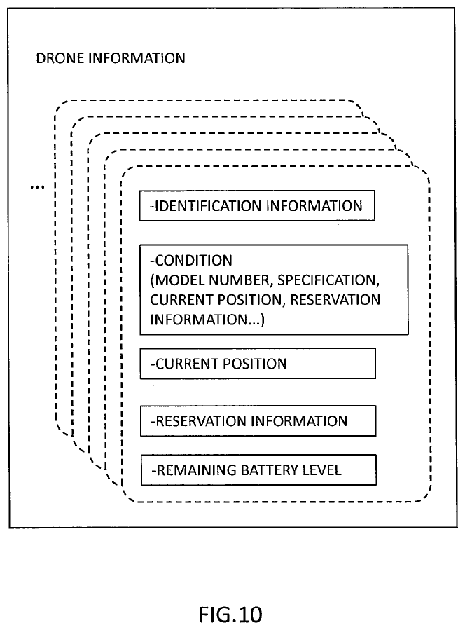

The drone information D7 includes information on a drone used for delivery of a product. As illustrated in FIG. 10, for example, the drone information D7 associates a model number, a specification, a current position, reservation information, a remaining battery level, and the like with the identification information of the drone. The specification may be information indicating performance of the drone, such as weight, size, hovering time, maximum cruising distance, maximum flight altitude, and maximum wind pressure resistance of the drone.

Various conditions are imposed on the flight of the drone. Therefore, as will be described later, the three-dimensional space information D1, the setting condition D4, and the environment information D6 stored in the storage device 12 of the setting device 10B according to the second modification can include various types of information used in generating the flight route. Furthermore, as will be described later, the arithmetic circuit 11 sets the value of the unit space and generates the route of movement using the information included in the three-dimensional space information D1, the setting condition D4, and the environment information D6 in addition to the drone information D7.

### Favorable Altitude

The drone has a limited altitude at which it can fly. In addition, the altitude at which the drone can fly may be determined depending on the performance of each drone. The arithmetic circuit 11 reads the flight speed of the drone included in the drone information D7.

### Flight Speed

The flight speed may be determined by the performance of each drone. The arithmetic circuit 11 reads the flight speed of the drone from the drone information D7.

### Remaining Level and Consumption Amount of Battery

In a case where the drone uses a battery, a required battery consumption amount is required according to the flight distance. Furthermore, whether or not the target drone can be used is determined depending on the current remaining battery level. The arithmetic circuit 11 detects a remaining battery level or the like from the drone information D7 and selects a drone capable of flying back and forth between the landing and the destination.

### Emission Amount of Carbon Dioxide

When carbon dioxide is emitted due to the flight of the drone, information on the emission amount of carbon dioxide may be acquired from the drone information D7, and an ecological drone (emission amount of carbon dioxide is small) may be selected.

Number of Drones that can Fly in Target Time Zone

The number of drones is limited. Furthermore, there are also drones that are already allocated to other deliveries at some time. Therefore, the number of drones that can fly at the target time is also limited. In the generation of the flight route, the arithmetic circuit 11 detects information on a drone that can fly at a target time from the drone information D7.

### Flight Prohibited Area of Drone

The flight prohibited area of the drone is defined in advance by the Aviation Act or the like. For example, areas 150 m or more on the ground, areas around airports and the like, emergency service airspaces, areas above densely populated areas, and the like are drone flight prohibited areas. In addition, such a flight prohibited area cannot be a flight route of the drone. The three-dimensional space information D1 can associate identification information of each unit space with whether or not the area is a prohibited area of the drone. The arithmetic circuit 11 detects information on whether each unit space is a flight prohibited area from the three-dimensional space information D1.

### Flight Area of Another Drone

Some regions are already allocated to other drones. Such a region cannot be assigned to the flight of the target drone. In a case where a certain unit space is reserved as a flight route of the drone, the three-dimensional space information D1 can associate a date and time when the flight is reserved with the identification information of the unit space. The arithmetic circuit 11 detects and uses reservation information of each unit space from the three-dimensional space information D1.

### Flight Limitation Due to Weather

Rain or wind may affect the availability or speed of flight of the drone. The arithmetic circuit 11 detects and uses information on the weather of each unit space from the environment information D6.

### Landing Disaster

In a case where the landing of the drone cannot be used due to the disaster, the drone cannot be taken in and out from the landing. The arithmetic circuit 11 detects and uses a disaster at the landing from the environmental information D6.

### Generation of Wind Speed

In nature, wind may occur. A high wind speed affects the flight of the drone. For example, if the wind speed generated in the unit space is too high, the drone cannot fly. In such a case, the arithmetic circuit 11 refers to the environment information D6 and detects the wind speed generated in the target unit space. In addition, the arithmetic circuit 11 reads the specifications of the target drone from the drone information D7. Furthermore, the arithmetic circuit 11 determines whether the wind speed generated in the target unit space is allowable for the target drone. Note that the arithmetic circuit 11 may consider the wind speed generated by the drone flying in the adjacent unit space in addition to the wind generated naturally.

### Increase in Temperature

In some cases, an allowable temperature raised by the drone is determined in the unit space. In such a case, the arithmetic circuit 11 reads the allowable rising temperature from the setting condition D4. In addition, the arithmetic circuit 11 calculates and uses the temperature at which the drone raises the unit space from the specifications of the target drone included in the drone information D7.

The arithmetic circuit 11 can generate the flight route according to a condition of whether the flight route is “fee priority” or “date and time priority”. The fee priority is given to a route with a lower fee of the product delivery. In the date and time priority, a route through which the product is delivered at a date and time closer to the desired date and time is generated. Therefore, the route generation method differs depending on which is prioritized.

### (Calculation of Optimal Route 1: Fee Priority)

For example, it is assumed that the value is set to be different according to the altitude from the ground. At this time, the arithmetic circuit 11 selects, from the plurality of unit spaces, a unit space having a low value, which connects the landing and the destination, and generates the optimum route. Specifically, the arithmetic circuit 11 selects a unit space connecting from the landing to the destination and from the destination to the landing. At this time, the arithmetic circuit 11 selects a unit space having a lower value. A route generated by selecting a unit space having a lower value is an optimal route in a case of fee priority. The value of the unit space can be calculated according to the use rate of the unit space.

### (Calculation of Optimal Distance 2: Date and Time Priority)

The arithmetic circuit 11 generates an optimal route by a method similar to the fee priority described above. In addition, when the product can be delivered at the designated date and time with the generated optimal route, the arithmetic circuit 11 sets this optimal route as the optimal route in the case of date and time priority. When the product cannot be delivered at the specified date and time, the arithmetic circuit 11 reselects the unit space of the altitude having high value and generates the route. This is because, for example, even in a case where the unit space of the altitude having low value is already reserved, the unit space of the altitude having high value may be available at a desired date and time. For example, the arithmetic circuit 11 changes the altitude to generate an optimal route through which the product can be delivered at a designated date and time.

### (Use Rate)

The use rate of each unit space in a certain time zone is calculated by using, for example, the frequency at which the unit space is used and/or the frequency at which the unit space is scheduled to be used in the time zone, and the frequency at which the unit space is used and/or the frequency at which the unit space is scheduled to be used in the target unit space in the same time zone in the past year. Here, the use frequency of the unit space can be expressed by the number of drones using the unit space. At this time, the situation for each day of the week may be considered in addition to the time zone. For example, in order to calculate the use rate R of a certain unit space for 59 seconds from 12:01:00 on Wednesday, December 12, the following Formula (2.1) can be used.

$$R = C 1 / C 2 \qquad ( 2.1 )$$

C1: The number of drones using the target unit space for 59 seconds from 12:01:00 on Wednesday, December 12
C2: The number of drones using the target unit space for 59 seconds from 12:01:00 on Wednesday in the past year

Note that each unit space is allocated to only one drone. Therefore, two or more drones do not exist in one unit space at the same time.

### (Value of Unit Space)

The value of each unit space may be different for each altitude, for example. In addition, the base unit price may be determined according to the altitude of the unit space. Specifically, the base unit price may be determined every 10 m. For example, the following Formula (2.2) can be used to calculate the value P of the unit time (for example, 60 seconds) of a unit space at an altitude of 105 m.

$$P = Pb \times R \qquad ( 2.2 )$$

Pb: Base unit price of unit space at altitude of 100 to 110 m
R: Use rate of target unit space

As a result, the unit price can be calculated for each unit space.

Furthermore, for example, the value P of the unit time of the unit space may be different according to the number of API calls which is a signal indicating the number of times of space utilization (transaction) transmitted from the user of the user terminal 20 who is the user of the three-dimensional space to a manager of the unit space. Specifically, a coefficient determined according to the number of API calls may be added to or multiplied by Formula (2.2).

Note that, for example, the base unit price of the unit space that is the landing place of the drone may be set to be higher than the base unit price of other unit spaces. In addition, for example, the base unit price of a unit space in which fine weather continues at a high frequency may be set to be higher than the base unit price of other unit spaces. This is because such a unit space is expected to be used with high frequency.

### (Delivery Fee Using Generated Route)

The fee required for the product delivery using the route connecting the plurality of unit spaces may be determined by the unit price of each unit space and the time during which the drone occupies each unit space. For example, the following Formula (2.3) can be used as the fee V required for the movement of the route.

$$V = \sum Pbn \times Tn \qquad ( 2.3 )$$

Pbn: Base unit price of unit space
Tn: Time to use unit space

Note that the fee V may be discounted with respect to the amount of money calculated by Formula (2.3). For example, as in a so-called volume discount, the discount rate may be set to be higher as the fee is higher. Specifically, the arithmetic circuit 11 may use a coefficient subtracted or divided from the amount of money calculated by Formula (2.3).

Alternatively, the arithmetic circuit 11 may calculate the unit price required for using the unit space according to the specification determined for each type of drone and add the unit price to the fee calculated by Formula (2.3). For example, as in the following example, the unit price to be added is determined according to the maximum payload of the drone, the presence or absence of waterproofing, and the like.

| | | Presence or absence | |
|---|---|---|---|
| | Maximum payload | of waterproof | Unit price |
| A | 1000 g | Absent | 100 yen/10 sec |
| B | 2000 g | Absent | 200 yen/10 sec |
| C | 1000 g | Present | 120 yen/10 sec |

The maximum payload is 1000 g, and the unit price of the drone without waterproofing is 100 yen/10 sec. The maximum payload is 2000 g, and the unit price of the drone without waterproofing is 200 yen/10 sec. The maximum payload is 1000 g, and the unit price of the drone with waterproof is 120 yen/10 sec. Therefore, in the above example, the unit price increases as the maximum payload increases. In addition, in the above example, when the maximum payload is the same, the unit price is higher in the case of the presence of waterproof than in the case of the absence of waterproof.

### <Control Processing of Flight of Drone in Setting Device>

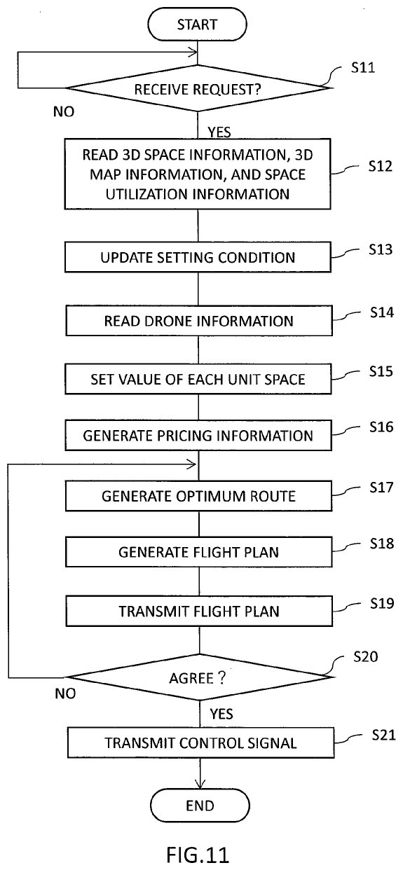

An example of a flow of processing in which the setting device 10A sets the value of the spatial information will be described with reference to a flowchart illustrated in FIG. 11.

The arithmetic circuit 11 determines whether a delivery request has been received from the user terminal 20 via the network 30 (S11). For example, the request may include a delivery destination of the product, a weight of the product, a desired delivery date and time, and the like. The request may also include whether the user is fee first or delivery date and time first.

When receiving the request from the user terminal 20 (YES in S11), the arithmetic circuit 11 reads the three-dimensional space information D1, the three-dimensional map information D2, and the space utilization information D3 from the storage device 12 (S12). At this point, when the provisional cost or the like related to the delivery of the condition included in the delivery request can be calculated, the provisional cost or the like may be transmitted to the user terminal 20. As a result, the provisional cost is displayed on the output device 14 of the user terminal 20. The provisional cost may be, for example, information such as 1000 yen per 1 km.

The arithmetic circuit 11 updates the setting condition D4 (S13). Specifically, the arithmetic circuit 11 calculates the use rate of each unit space using the space utilization information D3. In addition, the arithmetic circuit 11 updates the use rate associated with the identification information of each unit space in the setting condition D4.

The arithmetic circuit 11 reads the drone information D7 from the storage device 12 (S14).

The arithmetic circuit 11 sets the value of each unit space defined by the three-dimensional space information D1 using the setting condition D4 and the drone information D7 (S15).

The arithmetic circuit 11 generates the pricing information D5 (S16). At this time, the pricing information D5 is data in which the value set in step S16 is associated with the identification information of each unit space.

The arithmetic circuit 11 generates the optimum route of the drone from each unit space using the three-dimensional space information D1, the space utilization information D3, the setting condition D4, the pricing information D5, the environment information D6, and the drone information D7 (S17). Here, in generating the optimal route, the arithmetic circuit 11 can set different routes as the optimal route according to the fee priority or the date and time priority included in the request received in step S11. Specifically, the arithmetic circuit 11 can generate the optimal route by sequentially selecting adjacent unit spaces from the unit space of the landing of the drone to the unit space of the destination and from the unit space of the destination to the unit space of the landing. Here, when an adjacent unit space is used, the arithmetic circuit 11 can generate a route for causing the drone to wait in the unit space before moving. Alternatively, the arithmetic circuit 11 can generate a route passing through another adjacent unit space when the adjacent unit space is used. Note that methods such as Dijkstra's algorithm, reinforcement learning, and use of a navigation mesh can be used to generate the optimal route.

In addition, if there is no drone at the target landing at the target time, it is necessary to move the drone from another place to the target landing. In such cases, the optimal route may also include movement from another location to the target landing.

Note that, for example, when the optimum route is generated in step S17, provisional reservation may be made in the space utilization information D3 for each unit space of the generated optimum route. In the provisional reservation, the use of each unit space of the optimal route is restricted in the optimal route for another request for a predetermined time (for example, 10 minutes) after the optimal route is generated.

The arithmetic circuit 11 generates a flight plan of the drone flying on the optimum route generated in step S14 (S18). The arithmetic circuit 11 selects a drone flying on the optimum route generated in step S14 at the desired delivery date and time included in the request received in step S11 from the information of the plurality of drones. In addition, the arithmetic circuit 11 calculates a delivery fee. The flight plan can include the delivery fee determined here. Further, the flight plan can also include a date and time of arrival of the drone. At this time, the arithmetic circuit 11 may generate image data indicating the flight plan.

Note that, when the drone flying on the optimum route generated in step S17 cannot be selected, the arithmetic circuit 11 changes the delivery date and time to the timing at which the drone flies according to the fee priority or the date and time priority included in the request.

The arithmetic circuit 11 transmits the flight plan generated in step S18 to the user terminal 20 via the network 30. (S19).

When the user agrees to cause the drone to fly in the flight plan transmitted in step S19 (YES in S20), the arithmetic circuit 11 transmits this flight plan to the operation terminal 40B (S21). As a result, the operation terminal 40B can control the drone 40A with the received control signal. Therefore, the drone 40A can realize delivery according to the user's desire.

On the other hand, when it is not agreed to fly the drone in the flight plan transmitted in step S19 (NO in S20), the process returns to step S17 and another optimal route is generated.

Note that, in the above example, a multicopter that moves in the air has been described as an example of the moving body. However, the moving body is not limited to a multicopter as long as the moving body moves in a three-dimensional space.

As described above, the setting device 10B according to the second modification can set a value to each unit space of the three-dimensional space. Here, the setting device 10B sets the value of the unit space according to the use rate calculated for each time zone of each unit space. Furthermore, the setting device 10B can obtain a route used for delivery on the basis of a value determined according to the use rate. At this time, the setting device 10B can generate the optimal route according to whether the user gives priority to the fee or priority to the date and time. As a result, the setting device 10B can cause delivery at a fee according to the user's desire.

### Third Modification

In the above example, an example of a drone flying in the air has been described. However, this similarly applies to a drone that moves under water. Here, for example, the concentration of a specific substance in the water may affect the drone. At this time, the value of each unit space may be set to be different according to the concentration of the specific substance in each unit space set in the water. One example of water containing a specific substance may be subsea containing APLS treated water.

Furthermore, in a case where the drone emits a specific substance, the concentration thereof may affect the value of the unit space. For example, when more substances are discharged, the value may be set to be high. The particular substance may be APLS treated water or carbon dioxide.

### Fourth Modification

In the above example, the value of the unit space in which the moving body moving in the space moves is determined. However, the unit space for setting the value is not limited to the unit space in which the moving body moves. Furthermore, here, the unit space is not limited to a so-called space such as air, space, or water, and may include the ground. For example, it can be used to determine a position where a server installed in a data center or an IoT device buried under the ground is installed. For example, a position where such a device such as a server or an IoT device is installed may be selected from the unit space for which the value is set as described above. As an example, in a case where an allowable temperature to be raised by the device is determined in the unit space, the allowable temperature is read from the setting condition D4, and the temperature at which the device to be installed raises the unit space is calculated and used.

### Fifth Modification

In the above description, an example in which the three-dimensional space information D1 is represented by predetermined absolute coordinates has been described. For example, the above description may be a terrestrial center astral body reference coordinate system. On the other hand, the coordinates may be coordinates based on the center of the sun. Specifically, the coordinates may be a solar system centroid astral body reference coordinate system. For example, when the three-dimensional space is in the air of a planet such as the earth, if a value is set for a unit space in the air, processing becomes easy by handling with coordinates based on the center of the planet. On the other hand, when the three-dimensional space is space, the processing becomes easy by using the coordinates based on the sun.

### Sixth Modification

In the above description, an example in which the unit space is a polyhedron has been described. However, each unit space may have a shape other than the polyhedron. For example, the plurality of unit spaces may be spaces arranged in multiple layers around the center of the earth, which is a sphere. By arranging a plurality of unit spaces in multiple layers from the center of the sphere, a sphere having a filling rate of 100% can be obtained. At this time, each unit space may be a curved surface in which the bottom surface portion and the upper surface portion match the sphere. For example, by arranging all the unit spaces in the same layer, a sphere is formed by the upper surface portions of the plurality of unit spaces. At this time, the unit spaces of the same layer have the same shape. Further, the unit spaces of the different layers may not have the same shape. Note that the unit space may be arranged only in a hierarchy in which the unit space is required. For example, the unit space may not be arranged deep in the ground where it is not necessary to define the unit space.
<1> A setting method of the present invention is a setting method for setting a value of a three-dimensional space executed in an arithmetic circuit connected to a storage device, wherein:
the three-dimensional space includes a plurality of unit spaces, each of the unit spaces is provided with identification information for uniquely identifying each of the unit spaces;
the storage device stores space utilization information in which identification information of the plurality of unit spaces is associated with information indicating a frequency of use of each of the unit spaces per unit time,
the arithmetic circuit:
reading the space utilization information from the storage device;
calculating a use rate of each unit space using a frequency in which each unit space represented by the space utilization information is used per unit time; and
setting value information indicating a value of each unit space according to the use rate of each unit space.
<2> In the setting method according to <1>, the arithmetic circuit may generate, for each of the unit spaces, pricing information in which the identification information and the value information are associated with each other and store the generated pricing information in the storage device.
<3> In the setting method according to <1> or <2>, the arithmetic circuit may be connected to a display device, and
the storage device may store three-dimensional space information associating identification information of each of the unit spaces with information indicating a position of the unit space in the three-dimensional space,
the arithmetic circuit may:
generate a composite image in which the set value is associated with an image indicating each of the unit spaces; and
cause the display device to display the composite image.
<4> In the setting method according to any one of <1> to <3>, the space utilization information may include a time at which the unit space is used and/or a time at which the unit space is scheduled to be used, and
the arithmetic circuit may calculate a use rate for each time when the unit space is used and/or a time zone when the unit space is scheduled to be used.
<5> In the setting method according to any one of <1> to <4>, the space utilization information may include a target using the unit space, and
the arithmetic circuit may calculate a use rate of the target using the unit space.
<6> In the setting method according to any one of <1> to <5>, each of the unit spaces may be a polyhedron of any one of a rectangular parallelepiped, a cube, and a parallelepiped.
<7> In the setting method according to any one of <1> to <5>, each of the unit spaces may have a shape in which the unit spaces are arranged in multiple layers on an outer side from a center of a sphere, and a bottom surface portion and an upper surface portion may be formed by curved surfaces along the sphere.
<8> In the setting method according to any one of <1> to <7>, the value information may vary depending on an altitude or an elevation of a unit space.
<9> A setting device of the present invention is a setting device that includes an arithmetic circuit connected to a storage device and sets a value of a three-dimensional space, wherein:
the three-dimensional space includes a plurality of unit spaces, each of the unit spaces is provided with identification information for uniquely identifying each of the unit spaces,
the storage device stores space utilization information in which identification information of the plurality of unit spaces is associated with information indicating a frequency of use of each of the unit spaces per unit time,
the arithmetic circuit, reading the space utilization information from the storage device,
calculating a use rate of each unit space using a frequency in which each unit space represented by the space utilization information is used per unit time, and
setting value information indicating a value of each unit space according to the use rate of each unit space.
<10> A computer program of the present invention causes an information processing apparatus to execute the setting method described in any one of <1> to <8>.

The present invention is useful for setting a value to a three-dimensional space when using geospatial information.

What is claimed is:

1. A setting method for setting a value of a three-dimensional space executed in an arithmetic circuit connected to a storage device, wherein:
the three-dimensional space includes a plurality of unit spaces in which a moving body is movable, each of the unit spaces is provided with identification information for uniquely identifying each of the unit spaces;
the moving body is movable in a horizontal direction or a vertical direction to another unit space adjacent to a unit space including a current position;
the value of the three-dimensional space indicates a cost generated in a case where the moving body moves in the three-dimensional space; and
the storage device stores space utilization information in which identification information of the plurality of unit spaces is associated with information indicating a frequency of use of each of the unit spaces per unit time,
the arithmetic circuit:
reading the space utilization information from the storage device;
calculating a ratio of a number of times of use by the moving body in a unit time corresponding to the predetermined time zone to a number of times of use by the moving body in a past predetermined time zone for each unit space represented by the space utilization information as a use rate of each unit space in which each unit space is used by an arbitrary moving body; and
setting value information indicating a value of each unit space by adding the use rate of each unit space and a reference value predetermined for each unit space.

2. The setting method according to claim 1, wherein
the arithmetic circuit generates, for each of the unit spaces, pricing information in which the identification information and the value information are associated with each other and stores the generated pricing information in the storage device.

3. The setting method according to claim 1, wherein
the arithmetic circuit is connected to a display device, and
the storage device stores three-dimensional space information associating identification information of each of the unit spaces with information indicating a position of the unit space in the three-dimensional space,
the arithmetic circuit:
generates a composite image in which the set value is associated with an image indicating each of the unit spaces, and
causes the display device to display the composite image.

4. The setting method according to claim 1, wherein
the space utilization information includes a time at which the unit space is used and/or a time at which the unit space is scheduled to be used, and
the arithmetic circuit calculates a use rate for each of the past predetermined time zone in which the unit space is used and/or a time zone at which the unit space is scheduled to be used.

5. The setting method according to claim 1, wherein
the space utilization information includes information on the moving body that uses the unit space, and
the arithmetic circuit calculates a use rate of each moving body that uses the unit space.

6. The setting method according to claim 1, wherein each of the unit spaces is a polyhedron of any one of a rectangular parallelepiped, a cube, a parallelepiped, and a hexagonal prism.

7. The setting method according to claim 1, wherein each of the unit spaces has a shape in which the unit spaces are arranged in multiple layers on an outer side from a center of a sphere, and a bottom surface portion and an upper surface portion are formed by curved surfaces along the sphere.

8. The setting method according to claim 1, wherein the value information varies depending on an altitude or an elevation of the unit space.

9. A setting device comprising an arithmetic circuit connected to a storage device, the setting device setting a value of a three-dimensional space, wherein:
the three-dimensional space includes a plurality of unit spaces in which a moving body is movable, each of the unit spaces is provided with identification information for uniquely identifying each of the unit spaces;
the moving body is movable in a horizontal direction or a vertical direction to another unit space adjacent to a unit space including a current position;
the value of the three-dimensional space indicates a cost generated in a case where the moving body moves in the three-dimensional space; and
the storage device stores space utilization information in which identification information of the plurality of unit spaces is associated with information indicating a frequency of use of each of the unit spaces per unit time,
the arithmetic circuit reading the space utilization information from the storage device,
calculating a ratio of a number of times of use by the moving body in a unit time corresponding to the predetermined time zone to a number of times of use by the moving body in a past predetermined time zone for each unit space represented by the space utilization information as a use rate of each unit space in which each unit space is used by an arbitrary moving body, and
setting value information indicating a value of each unit space by adding the use rate of each unit space and a reference value predetermined for each unit space.

10. A non-transitory computer readable medium storing a computer program, the computer program including a plurality of instructions, and when the plurality of instructions is executed by a computer, the plurality of instructions causes the computer to perform the setting method according to claim 1.
